(19) United States
(12) Patent Application Publication
(10) Pub. No.: US 2022/0307308 A1
(43) Pub. Date: Sep. 29, 2022

(54) BRAKING SYSTEM FOR SLIDING DOORS

(71) Applicant: Oldcastle BuildingEnvelope, Inc., Dallas, TX (US)

(72) Inventors: Conor McDonald, Cleveland, OH (US); Nathan Patrick, Wales, WI (US)

(21) Appl. No.: 17/702,869

(22) Filed: Mar. 24, 2022

Related U.S. Application Data
(60) Provisional application No. 63/165,711, filed on Mar. 24, 2021.

(51) Int. Cl. E05F 5/00

(52) U.S. Cl. CPC E05F 5/003; E05Y 2201/21; E05Y 2201/256; E05Y 2201/26; E05Y 2201/264; E05Y 2201/46; E05Y 2800/22; E05Y 2900/132; E05Y 2900/148

(57) ABSTRACT

A braking system for a sliding door system includes a receiver and a driving wedge. The receiver is at a fixed location along a travel path and includes a first braking surface. The driving wedge is attachable to a sliding door assembly of the sliding door system and includes a second braking surface. The driving wedge is movable along the travel path relative to the receiver between a disengaged configuration and an engaged configuration. In the disengaged configuration, the driving wedge is disengaged from the receiver, and, in the engaged configuration, the second braking surface frictionally engages the first braking surface.

### REFERENCE TO RELATED APPLICATION

This application claims the benefit of U.S. Provisional Patent Application No. 63/165,711, filed on Mar. 24, 2021 and entitled BRAKING SYSTEM FOR SLIDING DOORS, the content of which is hereby incorporated by reference in its entirety.

### FIELD OF THE INVENTION

The field of the invention relates to sliding door systems, and, more particularly, to braking systems for sliding door systems.

### BACKGROUND

Sliding doors are commonly included in various environments such as in a wall assembly to permit entry or exit from a particular location or otherwise allow for passage through the wall assembly. The forces used to open and close such sliding doors may be sufficiently large to damage components of the door system (e.g., the track, door frame, the door itself, rollers, etc.). To minimize such forces, some sliding doors may include a braking system. However, existing braking systems are complex and require a number of interacting components to work effectively. Such braking systems are difficult to install and service, may be susceptible to failure or damage due to the number of interacting parts, and require significant modifications to a door carriage supporting the sliding door.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments, a sliding door system includes a sliding door assembly, a receiver, and a driving wedge. The sliding door assembly is movable along a travel path, and the receiver is at a braking location along the travel path that is fixed along the travel path. In various embodiments, the receiver includes a first braking surface. The driving wedge is attached to the sliding door assembly and is fixed relative to the sliding door assembly. In various embodiments, the driving wedge is movable with the sliding door assembly along the travel path and substantially parallel to the receiver. The driving wedge includes a second braking surface that is configured to selectively frictionally engage the first braking surface of the receiver when the driving wedge is at the braking location.

In some embodiments, the sliding door assembly comprises a door and a carriage supporting the door and the driving wedge is attached to the door or the carriage. In various examples, the receiver is movable in a direction substantially perpendicular to the travel path as the wedge surface selectively frictionally engages the braking surface. In some cases, the receiver includes a biasing element biasing the receiver toward the travel path in the direction substantially perpendicular to the travel path.

In certain embodiments, the driving wedge is movable along the travel path between an engaged configuration and a disengaged configuration relative to the receiver. In some cases, in the disengaged configuration, the driving wedge is spaced apart from the receiver and the braking location, and, in the engaged configuration, the driving wedge is at the braking location such that at least a portion of the first braking surface engages at least a portion of the second braking surface. In various embodiments, in the engaged configuration, the driving wedge is movable along the travel path between a minimum engagement position and a maximum engagement position, and the engaged region in the maximum engagement position is greater than the engaged region in the minimum engagement position.

In some embodiments, the first braking surface extends at an oblique angle relative to the travel path and the second braking surface extends at an oblique angle relative to the travel path. In certain cases, the first braking surface may define a locking groove, and the second braking surface may define a locking rib that selectively engages the locking groove.

According to certain embodiments, a braking system for a sliding door system includes a receiver and a driving wedge. The receiver is positionable at a braking location along a travel path and includes a first braking surface. The braking location may be fixed along the travel path. The driving wedge is attachable to a sliding door assembly of the sliding door system, and the driving wedge includes a second braking surface. In certain aspects, the driving wedge is movable along the travel path relative to the receiver between a disengaged configuration and an engaged configuration. In various embodiments, in the disengaged configuration, the driving wedge is disengaged from the receiver and is not at the braking location, and, in the engaged configuration, the driving wedge is at the braking location such that the second braking surface frictionally engages the first braking surface.

In various embodiments, in the engaged configuration, the driving wedge and the receiver define an engaged region where at least a portion of the first braking surface engages at least a portion of the second braking surface. In some cases, in the engaged configuration, the driving wedge is movable along the travel path between a minimum engagement position and a maximum engagement position. The engaged region in the maximum engagement position may be greater than the engaged region in the minimum engagement position.

In some embodiments, the receiver is movable in a direction substantially perpendicular to the travel path. In certain embodiments, frictional engagement between the first braking surface and the second braking surface in the engaged configuration moves the receiver in the direction substantially perpendicular to the travel path. In various cases, the receiver is parallel to the driving wedge along the travel path.

A sliding door system may include a sliding door assembly and the braking system.

According to certain embodiments, a sliding door system includes a door carriage and a braking system. The door carriage is configured to support a sliding door and is movable along a travel path. The braking system includes a receiver and a driving wedge. The receiver may be at a braking location along the travel path and includes a first braking surface, and the door carriage is movable along the travel path relative to the receiver while the receiver is fixed at the braking location along the travel path. The driving wedge is movable with the door carriage along the travel path and includes a second braking surface that is fixed relative to the door carriage. The second braking surface is configured to selectively engage the first braking surface.

In some embodiments, the sliding door system includes the sliding door, and the driving wedge is attached to at least one of the sliding door or the door carriage.

The second braking surface may be configured to selectively frictionally engage the first braking surface. In certain embodiments, the receiver is substantially parallel to the driving wedge along the travel path. In various embodiments, at least a portion of the first braking surface extends at an oblique angle relative to the travel path, and at least a portion of the second braking surface extends at an oblique angle relative to the travel path. The oblique angle of the first braking surface may be the same as the oblique angle of the second braking surface.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a top view of a sliding door system with a braking system in a disengaged configuration according to aspects of the current disclosure.

FIG. 2 is a top view of the sliding door system of FIG. 1 with the braking system in an engaged configuration.

FIG. 3 is a perspective view of a sliding door system with a braking system in a disengaged configuration according to aspects of the current disclosure.

FIG. 4 is a perspective view of the sliding door system of FIG. 3 with the braking system in an engaged configuration.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing.

Certain aspects and features of the present disclosure relate to a braking system for a sliding door system and that includes a driving wedge and a receiver. The driving wedge may be movable along a travel path with a portion of the sliding door system including but not limited to a sliding door and/or a door carriage. The receiver may be at a braking location along the travel path that is fixed along the travel path. The driving wedge is configured to frictionally engage the receiver at the braking location and the frictional engagement may progressively provide resistance to movement of the sliding door along the travel path to slow down and/or stop the sliding door. The braking system described herein provides improved braking by minimizing and/or eliminating moving components needed to slow down and/or stop the sliding door. The braking system described herein also facilitates installation, repair, and/or replacement of the components of the braking system by minimizing the components needed to slow down and/or stop the sliding door at the braking location.

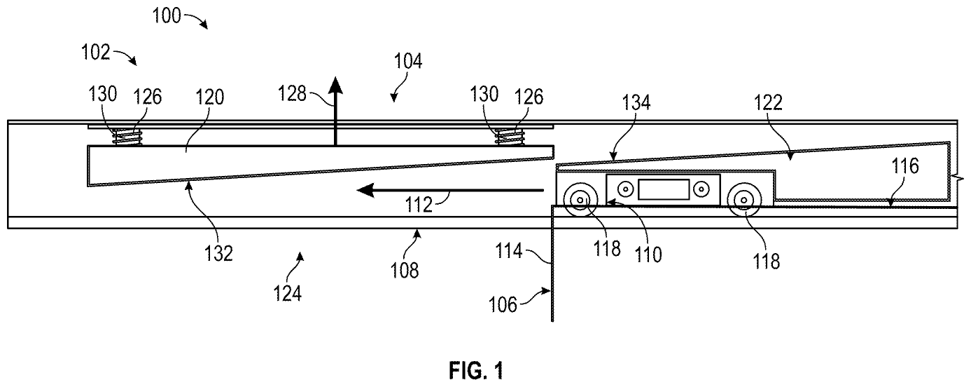

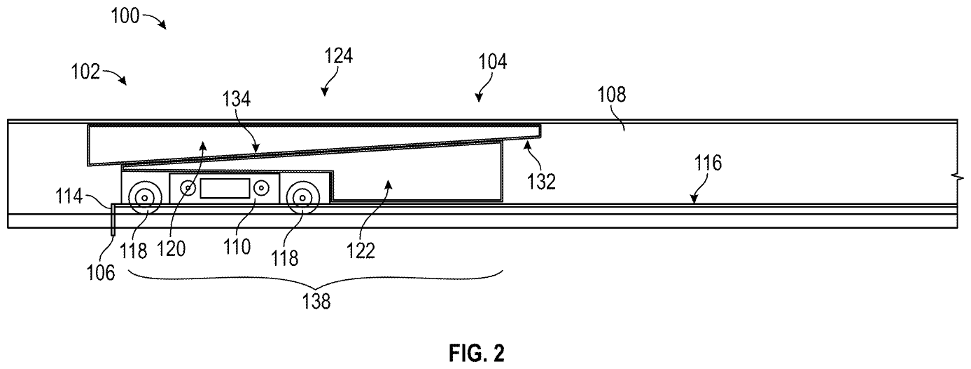

FIGS. 1 and 2 illustrate a sliding door system 100 with a sliding door assembly 102 and a braking system 104 according to various embodiments. The particular sliding door assembly 102 illustrated in FIGS. 1 and 2 should not be considered limiting on the disclosure, and the braking system 104 described herein may be provided with various other sliding door assemblies 102 as desired

As illustrated FIGS. 1 and 2, the sliding door assembly 102 generally includes a door 106, a rail 108, and at least one door carriage 110. In some embodiments, the sliding door assembly 102 may be a component of a wall installation (e.g., an installation with one or more wall panels supported by a framing system), although it need not be in other examples. The rail 108 defines a travel path 112, and the at least one door carriage 110 supports the door 106 and is movable along the rail 108 such that the door 106 is movable along the travel path 112. In various embodiments, the sliding door assembly 102 includes a plurality of door carriages 110 supporting the door 106 such that the door 106 is movable along the travel path 112. The at least one door carriage 110 may be movable along the rail 108 via various suitable movement mechanisms as desired. In the embodiment of FIGS. 1 and 2, the at least one door carriage 110 includes two rollers 118 as movement mechanisms.

The door 106 includes a leading edge 114 and at least one side surface 116. Although not visible in FIGS. 1 and 2, the door 106 may also include a trailing edge opposite from the leading edge along the travel path 112, and the at least one side surface 116 may extend between the leading edge 114 and the trailing edge. The door 106 may be constructed from various materials as desired, including but not limited to glass, metal, plastics, composites, combinations thereof, or other suitable materials as desired. In the embodiment of FIGS. 1 and 2, the door 106 is a glass door. In some embodiments, and as illustrated in FIGS. 1 and 2, the door carriage 110 may support the door 106 offset from the at least one side surface 116, although the door carriage 110 need not be offset from the at least one side surface 116 in other embodiments.

As illustrated in FIGS. 1 and 2, the braking system 104 includes a receiver 120 and a driving wedge 122. The braking system 104 defines a braking location 124 and may selectively slow down and/or stop movement of the door 106 along the travel path 112 at the braking location 124. In various aspects, the braking location 124 is fixed along the travel path 112, meaning that the particular location of the braking location 124 along the travel path 112 does not change. In other examples, the braking location 124 may be adjustable to various locations along the travel path 112 as desired. In certain aspects, the braking location 124 may be provided proximate to an end of the travel path 112 including but not limited to a location proximate to a vertical frame component of the sliding door system 100.

The receiver 120 is provided along the travel path 112 at the braking location 124 and may be supported at the braking location 124 via various suitable mechanisms or devices as desired. In certain aspects, the receiver 120 is fixed at the braking location 124, meaning that the receiver 120 does not travel along the travel path 112 relative to the braking location 124. Optionally, the receiver 120 may be movable at the braking location 124 in a direction 128 substantially perpendicular (or otherwise not parallel to) the travel path 112. In such examples, the receiver 120 may include one or more supports 126 that allow for movement of the receiver 120 in the direction 128. In the embodiment of FIGS. 1 and 2, the direction 128 is substantially perpendicular to the travel path 112, and the one or more supports 126 include two spring members 130 that bias the receiver towards the travel path 112. In other examples, other supports 126 may be utilized, and the supports 126 need not bias the receiver 120. Moreover, in other examples, the receiver 120 need not be movable in the direction 128 (i.e., the receiver 120 may be not be movable in any direction).

The receiver 120 includes a first braking surface 132 that is configured to frictionally engage the driving wedge 122 at the braking location 124. In various aspects, the first braking surface 132 is elongated along the travel path 112. As illustrated in FIGS. 1 and 2, the first braking surface 132 may extend at an oblique angle relative to the travel path 112 such that the braking surface 132 is not parallel to the travel path 112. As discussed in detail below, the first braking surface 132 at the oblique angle may allow for progressive engagement or disengagement between the first braking surface 132 and the driving wedge 122 and thereby allow for progressive braking of the door 106 or acceleration of the door 106 along the travel path 112. Optionally, the first braking surface 132 may include an alignment rib or groove that is configured to engage a corresponding alignment groove or rib on the driving wedge 122 when the driving wedge 122 is at the braking location 124.

The driving wedge 122 is movable with the sliding door assembly 102 along the travel path 112. In various embodiments, the driving wedge 122 is arranged substantially parallel to the receiver 120 along the travel path 112 such that the driving wedge 122 may selectively engage the receiver 120 along the travel path 112. In other words, the driving wedge 122 may be vertically aligned with the receiver 120 such that the driving wedge 122 may selectively engaged the receiver 120 without vertical movement. The driving wedge 122 may be connected to various components of the sliding door assembly 102 as desired, including but not limited to the at least one door carriage 110, the leading edge 114 of the door 106, and/or the at least one side surface 116 of the door 106. The driving wedge 122 may be connected to the sliding door assembly 102 via various suitable mechanisms or devices as desired, including but not limited to mechanical fasteners, tape, adhesives, friction fit engagement, combinations thereof, or as otherwise desired. In the embodiment of FIGS. 1 and 2, the driving wedge 122 is connected to the at least one door carriage 110. In certain aspects, the driving wedge 122 is fixed relative to the component of the sliding door assembly 102 to which it is connected. As one non-limiting example, in the embodiment of FIGS. 1 and 2, the driving wedge 122 may be fixed relative to the at least one door carriage 110 such that the driving wedge 122 is not movable relative to the at least one door carriage 110.

Similar to the receiver 120, the driving wedge 122 includes a second braking surface 134. In various embodiments, the second braking surface 134 is elongated along the travel path 112. In certain aspects, the second braking surface 134 may extend at an oblique angle relative to the travel path 112. In some cases, the angle of the second braking surface 134 may be the same angle as the first braking surface 132. Optionally, the second braking surface 134 may include the complimentary alignment groove or rib that selectively engages the alignment rib or groove on the first braking surface 132.

Referring to FIGS. 1 and 2, the driving wedge 122 is movable with the sliding door assembly 102 along the travel path 1121 such that the driving wedge 122 may be in a disengaged configuration (FIG. 1) or an engaged configuration (FIG. 2) with the receiver 120. In the disengaged configuration, the driving wedge 122 is spaced apart from the receiver 120 and the first braking surface 132 is disengaged from the second braking surface 134.

In various embodiments, in the engaged configuration, the driving wedge 122 is at the braking location 124 such that at least a portion of the first braking surface 132 frictionally engages at least a portion of the second braking surface 134. Frictional engagement may progressively provide resistance to movement of the door 106 along the travel path 112 towards the braking location 124 to slow down and/or stop the door 106. In various embodiments, in the engaged configuration, the receiver 120 may remain at its location along the travel path 112 and the driving wedge 122 may remain at its location relative to the sliding door assembly 102.

The portion of the first braking surface 132 engaged with the portion of the second braking surface 134 defines an engaged region 138 of the first braking surface 132 and the second braking surface 134. In certain embodiments, in the engaged configuration, the driving wedge 122 is movable along the travel path 112 between a minimum engagement position and a maximum engagement position. In such embodiments, the size (e.g., area or length along the travel path 112) of the engaged region 138 in the maximum engagement position is greater than the size of the engaged region 138 in the minimum engagement position. In some non-limiting embodiments, in the maximum engagement position, the entire first braking surface 132 may be engaged with the second braking surface 134 and/or vice versa. In other embodiments, the maximum engagement position is the largest engaged region 138 possible for the engaged first braking surface 132 and second braking surface 134. FIG. 2 illustrates the receiver 120 and the driving wedge 122 in the maximum engagement position.

In embodiments where the receiver 120 is movable in the direction 128, the driving wedge 122 in the engaged configuration (and movement between the minimum engagement position and the maximum engagement position) may both frictionally engage the receiver 120 and move the receiver 120 in the direction 128 away from the travel path 112. In such embodiments, movement of the receiver 120 in the direction 128 away from the travel path 112 while engaged with the driving wedge 122 may provide further braking to the door 106 moving along the travel path 112.

The receiver 120 and the driving wedge 122 may each be constructed from various suitable materials for frictional engagement as desired. As some non-limiting examples, the receiver 120 and/or the driving wedge 122 may be constructed from various plastics, metals, or composites as desired such as injection-molded plastics, die cast steel, and/or spring steel. It will be appreciated that the material of the receiver 120 need not be the same as the material of the driving wedge 122.

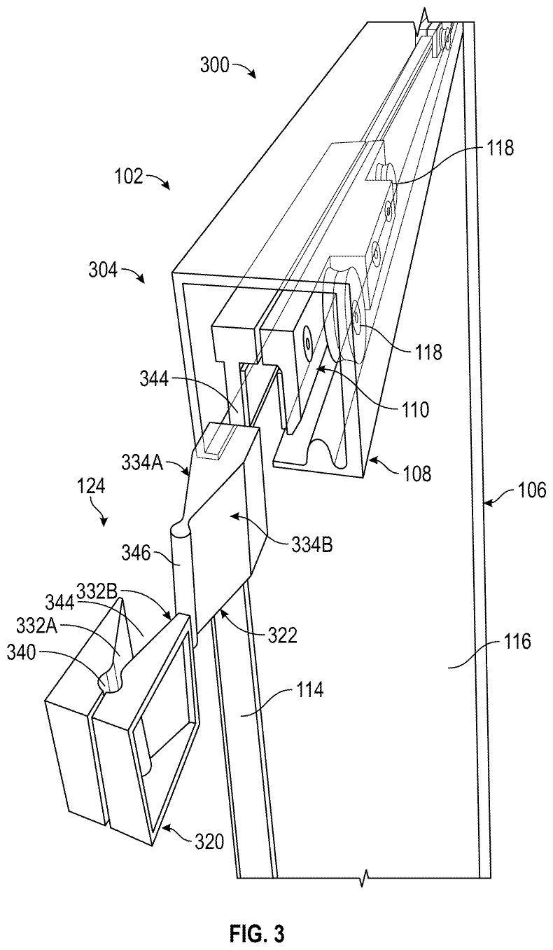

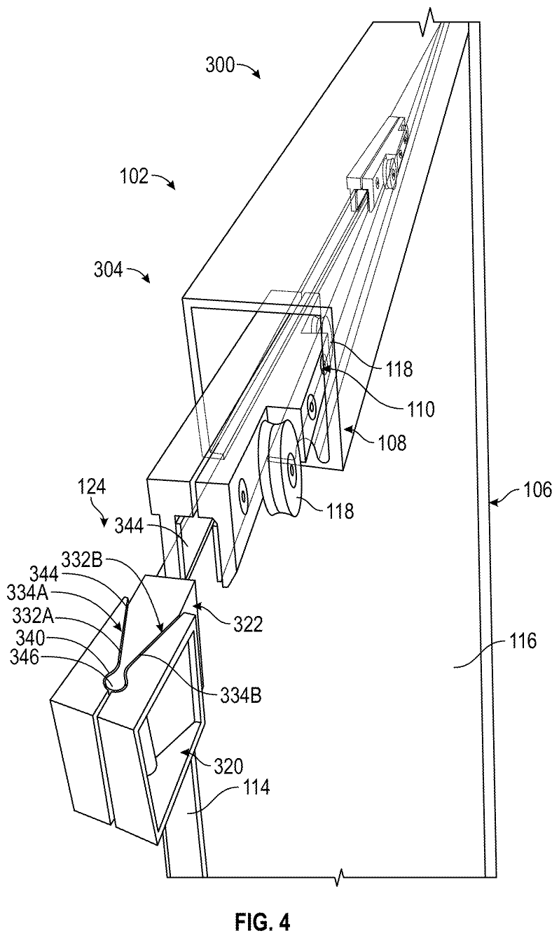

FIGS. 3 and 4 illustrate another example of a sliding door system 300 with the sliding door assembly 102 and a braking system 304 according to various embodiments. Similar to the braking system 104, the braking system 304 includes a receiver 320 and a driving wedge 322. As best illustrated in FIG. 4, in various examples, the receiver 320 and the driving wedge 322 are vertically aligned along the travel path 112 such that the receiver 320 may selectively engaged the driving wedge 322 without vertical movement.

Similar to the receiver 120, the receiver 320 is fixed along the travel path 112 at the braking location 124. Compared to the receiver 120, the receiver 320 includes a pair of opposing, inward-facing first braking surfaces 332A-B, and the first braking surfaces 332A-B together define a receiving channel 342. Similar to the first braking surface 132, the first braking surfaces 332A-B are elongated along the travel path 112 and extend at oblique angles relative to the travel path 112. Compared to the receiver 120, the receiver 320 also includes a locking groove 340. In the embodiment of FIGS. 3 and 4, the locking groove 340 is at an intersection of the first braking surfaces 332A-B within the receiving channel 342, although the particular location of the locking groove 340 should not be considered limiting, and the locking groove 340 may be provided at various other locations on the receiver 320 as desired.

Referring to FIGS. 3 and 4, compared to the driving wedge 122, the driving wedge 322 is connected to the leading edge 114 of the door 106. Optionally, the driving wedge 322 may at least partially overlap the side surfaces 116 and/or a top edge 344 of the door 106, although it need not in other embodiments. Compared to the driving wedge 122, the driving wedge 322 includes a pair of opposing, outward-facing second braking surfaces 334A-B. Similar to the second braking surface 134, the second braking surfaces 334A-B extend at oblique angles relative to the travel path. The driving wedge 322 also includes a locking rib 346 that is engageable with the locking groove 340. In the example of FIGS. 3 and 4, the locking rib 346 is at an intersection of the second braking surfaces 334A-B, although the location of the locking rib 346 should not be considered limiting on the disclosure.

FIG. 3 illustrates the sliding door system 300 with the braking system 304 in the disengaged configuration, and FIG. 4 illustrates the sliding door system 300 with the braking system 304 in the engaged configuration. As illustrated in FIG. 4, in the engaged configuration, the locking rib 346 is received within the locking groove 340, the first braking surface 332A is frictionally engaged with the second braking surface 334A, and the first braking surface 332B is frictionally engaged with the second braking surface 334B. Various other configurations of the receiver and/or driving wedge may be utilized as desired.

A method of using a sliding door system, such as the sliding door system 100, with a braking system, such as the braking system 104, may include moving the door 106 along the travel path 112 such that the driving wedge 122 moves from the disengaged configuration to the engaged configuration. The method may include further moving the door 106 along the travel path 112 such that the driving wedge 122 moves from the minimum engagement position to the maximum engagement position. Optionally, moving the door 106 along the travel path 112 such that the driving wedge 122 moves from the disengaged configuration to the engaged configuration and/or from the minimum engagement position to the maximum engagement position may move the receiver 120 in the direction 128 relative to the travel path. Optionally, the method may include moving the door 106 along the travel path 112 such that the driving wedge 122 moves from the maximum engagement position to the minimum engagement position and/or from the engaged configuration to the disengaged configuration.

A collection of exemplary embodiments are provided below, including at least some explicitly enumerated as “Illustrations” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A sliding door system comprising: a sliding door assembly movable along a travel path; a receiver at a braking location along the travel path, wherein the braking location is fixed along the travel path, wherein the receiver comprises a first braking surface; and a driving wedge attached to the sliding door assembly, wherein the driving wedge is fixed relative to the sliding door assembly and is movable with the sliding door assembly along the travel path and substantially parallel to the receiver, and wherein the driving wedge comprises a second braking surface that is configured to selectively frictionally engage the first braking surface of the receiver when the driving wedge is at the braking location.

Illustration 2. The sliding door system of any preceding or subsequent illustration or combination of illustrations, wherein the sliding door assembly comprises a door and a carriage supporting the door, and wherein the driving wedge is attached to the door or the carriage.

Illustration 3. The sliding door system of any preceding or subsequent illustration or combination of illustrations, wherein the receiver is movable in a direction substantially perpendicular to the travel path as the wedge surface selectively frictionally engages the braking surface at the braking location.

Illustration 4. The sliding door system of any preceding or subsequent illustration or combination of illustrations, wherein the receiver further comprises a biasing element biasing the receiver toward the travel path in the direction substantially perpendicular to the travel path.

Illustration 5. The sliding door system of any preceding or subsequent illustration or combination of illustrations, wherein the driving wedge is movable along the travel path between an engaged configuration and a disengaged configuration relative to the receiver, wherein, in the disengaged configuration, the driving wedge is spaced apart from the receiver and the braking location, and wherein, in the engaged configuration, the driving wedge is at the braking location such that at least a portion of the first braking surface engages at least a portion of the second braking surface.

Illustration 6. The sliding door system of any preceding or subsequent illustration or combination of illustrations, wherein, in the engaged configuration, the driving wedge is movable along the travel path between a minimum engagement position and a maximum engagement position, and wherein the engaged region in the maximum engagement position is greater than the engaged region in the minimum engagement position.

Illustration 7. The sliding door system of any preceding or subsequent illustration or combination of illustrations, wherein the first braking surface extends at an oblique angle relative to the travel path and wherein the second braking surface extends at an oblique angle relative to the travel path.

Illustration 8. The sliding door system of any preceding or subsequent illustration or combination of illustrations, wherein the first braking surface further defines a locking groove, and wherein the second braking surface further defines a locking rib that selectively engages the locking groove.

Illustration 9. A braking system for a sliding door system, the braking system comprising: a receiver at a braking location along a travel path and comprising a first braking surface, wherein the braking location is fixed along the travel path; a driving wedge attachable to a sliding door assembly of the sliding door system, wherein the driving wedge comprises a second braking surface, wherein the driving wedge is movable along the travel path relative to the receiver between a disengaged configuration and an engaged configuration, wherein, in the disengaged configuration, the driving wedge is disengaged from the receiver and is not at the braking location, and wherein, in the engaged configuration, the driving wedge is at the braking location such that the second braking surface frictionally engages the first braking surface.

Illustration 10. The braking system of any preceding or subsequent illustration or combination of illustrations, wherein, in the engaged configuration, the driving wedge and the receiver define an engaged region where at least a portion of the first braking surface engages at least a portion of the second braking surface, wherein, in the engaged configuration, the driving wedge is movable along the travel path between a minimum engagement position and a maximum engagement position, and wherein the engaged region in the maximum engagement position is greater than the engaged region in the minimum engagement position.

Illustration 11. The braking system of any preceding or subsequent illustration or combination of illustrations, wherein the receiver is movable in a direction substantially perpendicular to the travel path at the braking location.

Illustration 12. The braking system of any preceding or subsequent illustration or combination of illustrations, wherein frictional engagement between the first braking surface and the second braking surface in the engaged configuration moves the receiver in the direction substantially perpendicular to the travel path at the braking location.

Illustration 13. The braking system of any preceding or subsequent illustration or combination of illustrations, wherein the receiver is parallel to the driving wedge along the travel path.

Illustration 14. A sliding door system comprising a sliding door assembly and the braking system of any preceding or subsequent illustration or combination of illustrations.

Illustration 15. A sliding door system comprising: a door carriage configured to support a sliding door, wherein the door carriage is movable along a travel path; and a braking system comprising: a receiver at a braking location along the travel path and comprising a first braking surface, wherein the braking location is fixed along the travel path, and wherein the door carriage is movable along the travel path relative to the receiver; and a driving wedge movable with the door carriage along the travel path, wherein the driving wedge comprises a second braking surface that is fixed relative to the door carriage, and wherein the second braking surface is configured to selectively engage the first braking surface at the braking location.

Illustration 16. The sliding door system of any preceding or subsequent illustration or combination of illustrations, further comprising the sliding door, wherein the driving wedge is attached to at least one of the sliding door or the door carriage.

Illustration 17. The sliding door system of any preceding or subsequent illustration or combination of illustrations, wherein the second braking surface is configured to selectively frictionally engage the first braking surface at the braking location.

Illustration 18. The sliding door system of any preceding or subsequent illustration or combination of illustrations, wherein the receiver is substantially parallel to the driving wedge along the travel path at the braking location.

Illustration 19. The sliding door system of any preceding or subsequent illustration or combination of illustrations, wherein at least a portion of the first braking surface extends at an oblique angle relative to the travel path, and wherein at least a portion of the second braking surface extends at an oblique angle relative to the travel path.

Illustration 20. The sliding door system of any preceding or subsequent illustration or combination of illustrations, wherein the oblique angle of the first braking surface is the same as the oblique angle of the second braking surface.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described invention, nor the claims that follow.

That which is claimed is:

1. A sliding door system comprising:
a sliding door assembly movable along a travel path;
a receiver at a braking location along the travel path, wherein the braking location is fixed along the travel path, and wherein the receiver comprises a first braking surface; and
a driving wedge attached to the sliding door assembly, wherein the driving wedge is fixed relative to the sliding door assembly and is movable with the sliding door assembly along the travel path and substantially parallel to the receiver, and wherein the driving wedge comprises a second braking surface that is configured to selectively frictionally engage the first braking surface of the receiver when the driving wedge is at the braking location.

2. The sliding door system of claim 1, wherein the sliding door assembly comprises a door and a carriage supporting the door, and wherein the driving wedge is attached to the door or the carriage.

3. The sliding door system of claim 1, wherein the receiver is movable in a direction substantially perpendicular to the travel path as the wedge surface selectively frictionally engages the braking surface at the braking location.

4. The sliding door system of claim 3, wherein the receiver further comprises a biasing element biasing the receiver toward the travel path in the direction substantially perpendicular to the travel path.

5. The sliding door system of claim 1, wherein the driving wedge is movable along the travel path between an engaged configuration and a disengaged configuration relative to the receiver, wherein, in the disengaged configuration, the driving wedge is spaced apart from the receiver and the braking location, and wherein, in the engaged configuration, the driving wedge is at the braking location such that at least a portion of the first braking surface engages at least a portion of the second braking surface and defines an engaged region of the first braking surface and the second braking surface.

6. The sliding door system of claim 5, wherein, in the engaged configuration, the driving wedge is movable along the travel path between a minimum engagement position and a maximum engagement position, and wherein the engaged region in the maximum engagement position is greater than the engaged region in the minimum engagement position.

7. The sliding door system of claim 1, wherein the first braking surface extends at an oblique angle relative to the travel path and wherein the second braking surface extends at an oblique angle relative to the travel path.

8. The sliding door system of claim 1, wherein the first braking surface further defines a locking groove, and wherein the second braking surface further defines a locking rib that selectively engages the locking groove.

9. A braking system for a sliding door system, the braking system comprising:
a receiver at a braking location along a travel path and comprising a first braking surface, wherein the braking location is fixed along the travel path; and
a driving wedge attachable to a sliding door assembly of the sliding door system, wherein the driving wedge comprises a second braking surface, wherein the driving wedge is movable along the travel path relative to the receiver between a disengaged configuration and an engaged configuration, wherein, in the disengaged configuration, the driving wedge is disengaged from the receiver and is not at the braking location, and wherein, in the engaged configuration, the driving wedge is at the braking location such that the second braking surface frictionally engages the first braking surface.

10. The braking system of claim 9, wherein, in the engaged configuration, the driving wedge and the receiver define an engaged region where at least a portion of the first braking surface engages at least a portion of the second braking surface, wherein, in the engaged configuration, the driving wedge is movable along the travel path between a minimum engagement position and a maximum engagement position, and wherein the engaged region in the maximum engagement position is greater than the engaged region in the minimum engagement position.

11. The braking system of claim 9, wherein the receiver is movable in a direction substantially perpendicular to the travel path at the braking location.

12. The braking system of claim 11, wherein frictional engagement between the first braking surface and the second braking surface in the engaged configuration moves the receiver in the direction substantially perpendicular to the travel path at the braking location.

13. The braking system of claim 9, wherein the receiver is parallel to the driving wedge along the travel path.

14. A sliding door system comprising a sliding door assembly and the braking system of claim 9.

15. A sliding door system comprising:
a door carriage configured to support a sliding door, wherein the door carriage is movable along a travel path; and
a braking system comprising:
a receiver at a braking location along the travel path and comprising a first braking surface, wherein the braking location is fixed along the travel path, and wherein the door carriage is movable along the travel path relative to the receiver; and
a driving wedge movable with the door carriage along the travel path, wherein the driving wedge comprises a second braking surface that is fixed relative to the door carriage, and wherein the second braking surface is configured to selectively engage the first braking surface at the braking location.

16. The sliding door system of claim 15, further comprising the sliding door, and wherein the driving wedge is attached to at least one of the sliding door or the door carriage.

17. The sliding door system of claim 15, wherein the second braking surface is configured to selectively frictionally engage the first braking surface at the braking location.

18. The sliding door system of claim 15, wherein the receiver is substantially parallel to the driving wedge along the travel path at the braking location.

19. The sliding door system of claim 15, wherein at least a portion of the first braking surface extends at an oblique angle relative to the travel path, and wherein at least a portion of the second braking surface extends at an oblique angle relative to the travel path.

20. The sliding door system of claim 19, wherein the oblique angle of the first braking surface is the same as the oblique angle of the second braking surface.
